(19) United States
(12) Patent Application Publication
(10) Pub. No.: US 2013/0272006 A1
(43) Pub. Date: Oct. 17, 2013

(54) Light Emitting Device Of A Car Threshold

(71) Applicant: Chang-An YANG, New Taipei City (TW)

(72) Inventor: Chang-An YANG, New Taipei City (TW)

(73) Assignee: HON YU AUTO PARTS CO., LTD., New Taipei City (TW)

(21) Appl. No.: 13/592,188

(22) Filed: Aug. 22, 2012

(30) Foreign Application Priority Data
Apr. 13, 2012 (TW) TW101113108

(51) Int. Cl. B60Q 3/00

(52) U.S. Cl. 362/488

(57) ABSTRACT

A light emitting device of a car threshold contains a threshold body including a cover and a lid; at least one least one guiding strap disposed in the threshold body and inserted through the cover, the guiding strap including a first end portion and a second end portion, wherein the first end portion is defined on the least one least one guiding strap guiding strap to correspond to and face to the lid; an illumination element used to reflect a light source toward the second end portion of the at least one guiding strap. Thereby, the light emitting device emits the gentle decorative light through the cover and reflects the light source via the lid simultaneously by connecting the illumination element and the at least one guiding strap together.

### BACKGROUND OF THE INVENTION

1. Field of the Invention

The present invention relates to a light emitting device, and more particularly to a light emitting device of a car threshold which emits the gentle decorative light and simultaneously reflects the light source.

2. Description of the Prior Art

Conventional light emitting device includes a decorative light supply and an illuminative light source, wherein the decorative light supply is fixed in a hidden position of the car to emit decorative light, yet the illuminative light source is mounted in a reading illumination position of the car to illuminate light source.

However, such decorative light and light source generate from two different light emitting devices, thereby having complicated structure and higher production cost.

The present invention has arisen to mitigate and/or obviate the afore-described disadvantages.

### SUMMARY OF THE INVENTION

The primary object of the present invention is to provide a light emitting device of a car threshold in which the colorful light from the illumination element is conducted to the first end portion via the second end portion f the guiding strap, and then reflects the light source via the lid, thus illuminating an indoor floor of the car, such that the light emitting device emits the gentle decorative light through the cover and simultaneously reflects the light source via the lid by connecting the illumination element and the at least one guiding strap together.

To obtain the above objectives, a light emitting device of a car threshold according to the present invention contains:

a threshold body including a cover and a lid;

at least one least one guiding strap disposed in the threshold body and inserted through the cover, the guiding strap including a first end portion and a second end portion, wherein the first end portion is defined on the least one least one guiding strap to correspond to and face to the lid;

an illumination element used to reflect a light source toward the second end portion of the at least one guiding strap.

### BRIEF DESCRIPTION OF THE DRAWINGS

FIG. 1 is a perspective view showing the assembly of a light emitting device of a car threshold according to a first embodiment of the present invention.

FIG. 2 is a perspective view showing the exploded components of the light emitting device of the car threshold according to the first embodiment of the present invention.

FIG. 3 is a plan view showing the assembly of the light emitting device of the car threshold according to the first embodiment of the present invention.

FIG. 4 is a cross sectional view taken along lines A-A of FIG. 3.

FIG. 5 is a cross sectional view taken along lines B-B of FIG. 3.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

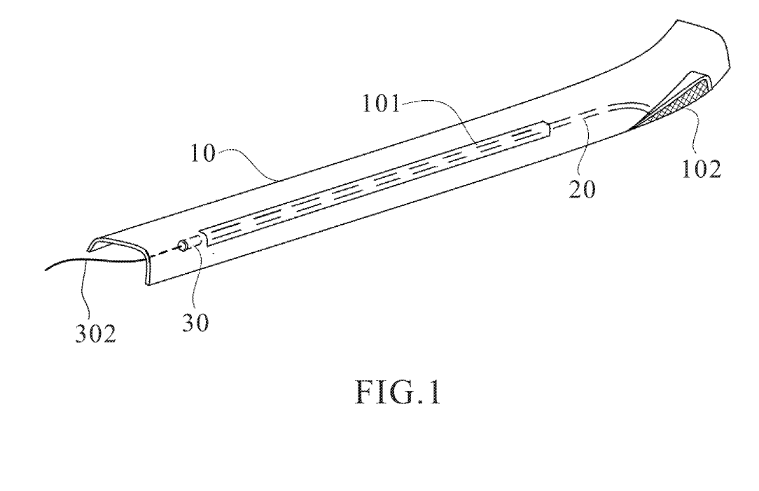

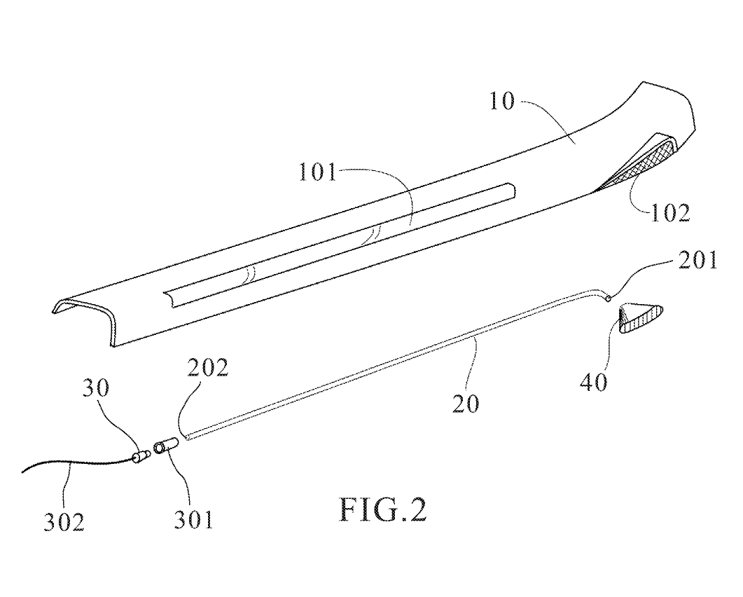

Referring to FIGS. 1 and 2, a light emitting device of a car threshold according to a preferred embodiment of the present invention comprises a threshold body 10 fixed on the car threshold, at least one guiding strap 20, and a light emitting element 30.

The threshold body 10 includes a cover 101 and a lid 102, both of which are made of a transparent material.

The at least one guiding strap 20 is disposed in the threshold body 10 and is inserted through the cover 101, the at least one guiding strap 20 includes a first end portion 201 and a second end portion 202, wherein the first end portion 201 is defined on the guiding strap 20 to correspond to and face to the lid 102, the first end portion 201 connects with an astigmatistic element 40. The at least one guiding strap 20 is foldable, flexible, and deformable and is formed in an elongated strap shape or a fixed shape.

The illumination element 30 is selected from a light emitting diode and a light bulb, and it is connected with the second end portion 202 of the at least one guiding strap 20 by using a connector 301, wherein the illumination element 30 is electrically connected with a battery pack, a power supply device or a power supply system of a car to supply power. The illumination element 30 is used to reflect a light source toward the second end portion of the at least one guiding strap

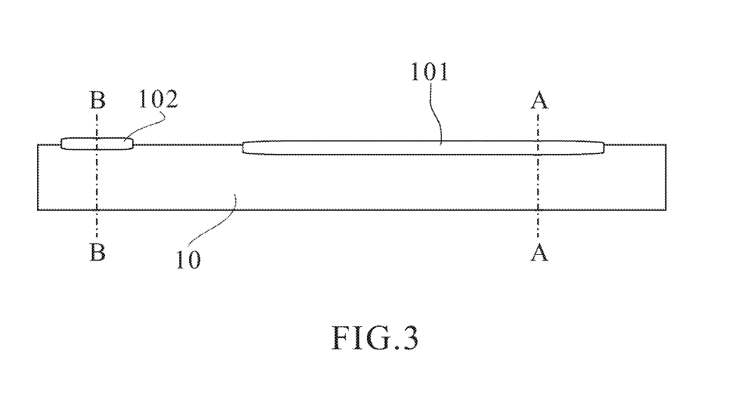

Thereby, the illumination element 30 and the at least one guiding strap 20 are connected together so that the cover 101 and the lid 102 of the threshold body 10 emit two different lights (as shown in FIG. 3) respectively by ways of the at least one guiding strap 20.

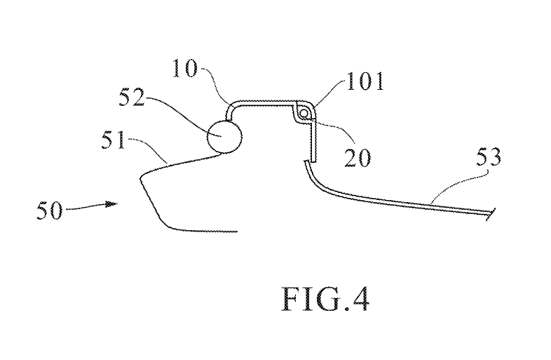

As shown in FIG. 4, the decorative light emits through the cover 101. Further referring to FIGS. 1 and 4, the light emitting device of the present invention is fixed on an inner side of the car threshold 50 spaced from an external threshold 51 by a waterproof rib 52 so that as closing the door, the light emitting device is not shielded by the door. In addition, a colorful light from the illumination element 30 is conducted by the at least one guiding strap 20 of the threshold body 10 and then emits a gentle decorative light through the cover 101, thereby achieving decorative lights in the car.

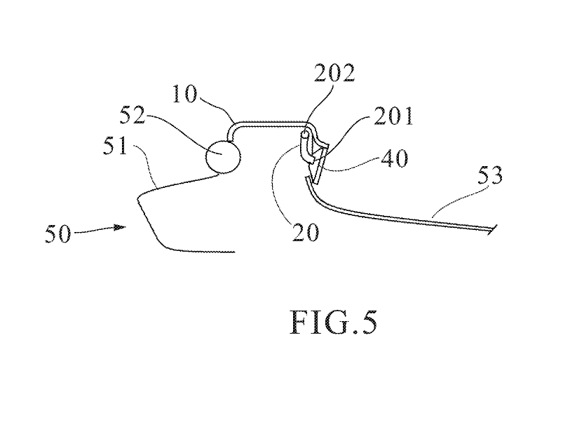

As illustrated in FIGS. 1 and 5, because the first end portion 201 of the at least one guiding strap 20 connects with the astigmatistic element 40 and is defined on the guiding strap 20 to correspond to the lid 102 and face to the lid 102, the colorful light from the illumination element 30 is conducted to the first end portion 201 via the second end portion 202 of the guiding strap 20, and then reflects the light source via the lid 102, thus illuminating an indoor floor of the car.

Thereby, the light emitting device of the present invention emits the gentle decorative light through the cover 101 and simultaneously reflects the light source via the lid 102 by connecting the illumination element 30 and the at least one guiding strap 20 together.

While we have shown and described various embodiments in accordance with the present invention, it is clear to those skilled in the art that further embodiments may be made without departing from the scope of the present invention.

What is claimed is:

1. A light emitting device of a car threshold comprising
a threshold body including a cover and a lid;
at least one least one guiding strap disposed in the threshold body and inserted through the cover, the guiding strap including a first end portion and a second end portion, wherein the first end portion is defined on the least one least one guiding strap to correspond to and face to the lid;
an illumination element used to reflect a light source toward the second end portion of the at least one guiding strap.

2. The light emitting device of the car threshold as claimed in claim 1, wherein the guiding strap is foldable and is formed in an elongated strap shape.

3. The light emitting device of the car threshold as claimed in claim 1, wherein the guiding strap is formed in a fixed strap shape.

4. The light emitting device of the car threshold as claimed in claim 1, wherein the illumination element is connected with the second end portion of the guiding strap by using a connector.

5. The light emitting device of the car threshold as claimed in claim 1, wherein the first end portion connects with an astigmatistic element.

6. The light emitting device of the car threshold as claimed in claim 1, wherein the illumination element is selected from a light emitting diode and a light bulb.
